(19) United States
(12) Patent Application Publication
(10) Pub. No.: US 2009/0233030 A1
(43) Pub. Date: Sep. 17, 2009

(54) DYNAMIC STAIN GLASS WINDOW

(76) Inventor: Don M. Ferris, Woodland, WA (US)

Correspondence Address: Bruce E. Harang, PO BOX 872735, VANCOUVER, WA, 98687-2735, US

(21) Appl. No.: 12/471,438

(22) Filed: May 25, 2009

Related U.S. Application Data
(63) Continuation-in-part of application No. 11/470,878, filed on Sep. 7, 2006.

(51) Int. Cl. B44F 1/06

(52) U.S. Cl. 428/38

(57) ABSTRACT

A dynamic stain glass window utilizing a plurality of moving traditional lead came stain glass windows at least one of said lead came stain glass windows being moveably mounted in cooperative combination with a motorized drive system to provide the rotational movement of the windows and thereby create a changing lighted image to a viewer.

### BACKGROUND OF THE INVENTION

1. Field of the Invention

The present invention generally relates to a dynamic stain glass window, i.e. a stain glass window that provides a moving and changing light pattern to the viewer. More particularly the present invention relates to a multi-pane stain glass window suitable to produce a moving and changing stain glass window design which may be lighted in the traditional manner of natural daylight and/or by the more modern method of artificial back lighting i.e., spotlights, strobes, LED's, and lasers.

2. Description of the Related Art

Stain glass windows have been produced using a traditional methodology for centuries. Such a stain glass window would typically be made by cutting pieces of colored glass and skillfully fitting them together according to a pattern by using lead came, i.e. and H-shaped metal channel. Each individual piece of glass is cut by hand and meticulously fit to the pattern. The lead came is then soldered together at the joints to form an integral stain glass window. Such an assembled stain glass window may then be glazed; that is, a glaze compound developed for the purpose would be applied to the assembled window and brushed into the crevices between the cut pieces of glass and the lead came. The excess glaze would then be removed from the window surface. When the glaze hardened, it would cause the stain glass window to be substantially air and water tight.

The modern methodology of producing a traditional lead came stain glass window remains basically the same as it has for centuries. Such modern stain glass windows are generally made by drawing the design for the window on paper. A light table is used to trace this original design onto a second sheet of paper. Then using a pair of scissors having three blades where the second blade moves between the first and third blade thereby cutting a strip of paper that is just as wide as the middle part of the H shaped lead came which will fit between the glass pieces the second sheet is cut into individual pattern pieces. These individual pattern pieces are then put on the desired stain glass and using a glasscutter, each separate piece of stain glass for the design is cut to match the pattern piece. Once all of the pattern pieces are cut they are laid out on the original paper pattern to confirm they have been accurately cut to shape. To assemble the stain glass window the original paper design sheet is mounted on a wooden work board and horseshoe nails are driven into the wooden board along the outside border, such that when the lead came is pushed against the nails it will align with the outer edge of the original design. Glass is fitted into the lead came, then held in place with more horseshoe nails. More lead came is cut and formed along all sides of the glass pieces, then more stain glass is fitted into the window using the paper pattern as a guide. As the work progresses, the horseshoe nails are pulled out and moved to hold the edge of the growing window. This process continues until the window is fully assembled. Next all of the joints where the lead came meets are soldered. The horseshoe nails are removed and the window is put between two wood boards and flipped over so the second side can be soldered. Once the joints are soldered on both sides, the pieces of glass and lead came form a single window. This window is then glazed with a scrub brush, which pushes glazing compound between the stain glass and the lead came. Once the glazing compound is applied, a chemical powder is sprinkled over the window. Using a clean scrub brush, the window is vigorously buffed, which removes excess glazing compound and polishes the stain glass to a brilliant shine. The window is now finished and is basically air and water tight. If desired, steel reinforcement can be soldered to the back side of the window at a 90 degree angle to the window surface, along the lead came lines of the window to strengthen the window so it will not bow out over time from the weight of the lead came and stain glass.

This type of traditional lead came stain glass window is based on the effect of light passing through a colored glass thus creating a beautiful glowing image. The image is static, i.e. it never changes or moves and any change in the effect of the light passing through the glass is dependent on the movement of the light source, for example the course of the sun. For stain glass windows that are artificially lit, there usually is not even this light source movement to provide any visual change in the stain glass image.

More recently there have been stain glass windows that incorporate masks to provide less time consuming and expensive images. For example, U.S. Pat. No. 6,640,510 teaches a decorative stain glass window comprising stain glass and decorative metal within an insulated glass sandwich-like unit. This produces yet another form of static stain glass window.

U.S. Pat. No. 6,962,737 teaches a method of using electroluminescent materials in place of pieces of stain glass to create the effect of a backlit stain glass window panel. However, once again the window produced is a static stain glass effect design window.

U.S. Pat. No. 2,200,060 teaches a device which uses a plurality of discs comprising sheets having planar surfaces separated from one another by through spacer discs. These discs are mounted on a central shaft through a central aperture in each of said discs and spacer discs. This reference also teaches that the at least some of the discs may be rotated about a central shaft by means of gears but these gears and drive train assembly is not required to carry any weight as the central shaft is bearing the load of the discs. Additionally, this reference teaches the interchangeability of motor power and hand power to turn the discs. Finally, this reference discloses that the patterns displayed by the device rely upon the opaque sections of the discs to block light from the viewer of the device. U.S. Pat. No. 2,200,060 fails to disclose how to provide a disc having the weight of stain glass and lead came which may be rotated without the need of a central support shaft aperture in each stain glass and lead came window. This reference further fails to disclose how to create light patterns using refracted transmitted light as opposed to blocking light with opaque designs. In fact, this reference does not disclose, teach, or fairly suggest anything about creating any type of stain glass lead came window at all.

U.S. Pat. No. 6,594,929 teaches a display device which provides a continuous effect of changing colors through the use of at least two colored and/or colorless immiscible fluids flowing across the face of rotating discs. Theses immiscible fluids are collected along the bottom of the device by collection means provided along the outer edges of the discs. The discs are rotated by the use of friction pulleys driven by a motor and in friction contact with the edges of the discs. The discs must have as a critical element, seals between the discs to contain the various colored and/or colorless immiscible liquids and prevent them from co-mingling. This reference does therefore teach the use of creating patterns using transmitted light and the use of friction pulleys to turn the discs without the need for a central support shaft. However, this reference does not teach how to create a stain glass window using lead came to mount and hold the stain glass pieces together in such a manner that the window can be rotated. Nor does it teach how to combine planar stain glass window(s) with a clear beveled glass window to create light effects unknown to fifteen centuries of artisans skilled in this art.

U.S. Pat. No. 5,377,433 teaches a device and method of displaying a plurality of pendulums which move in a pivotal fashion along a horizontal axis of a central hub. The pendulums comprise a shaft onto the ends of which are mounted end members which may include transparent or translucent portions. The end members are created by using came members of a non-lead suitable structural material. Indeed if some of the larger pendulum ends disclosed utilized lead for the came they would fall apart from the pendulum movement of the device of this reference. These pendulums include a hub used to mount said pendulums to a pendulum support providing a pivotal movement point. A pendulum movement along a horizontal axis of a hub of a plurality of pendulums having decorative end units does not teach rotational movement adapted to use by traditional stain glass/lead came windows.

Stained glass windows have been made since the 5^{th} century. The standard technique for over 15 centuries is to produce a flat panel, two-dimensional window pane. Only recently has anybody thought of using a series of static two-dimensional windows to create a static three-dimensional stain glass window. A static three dimensional window has little practical use since the various layers of colored glass quickly make the three-dimensional effect disappear. The expense of all the stained glass and materials used to create a static three-dimensional window make it too expensive for most applications. For over 15 centuries stained glass artists have been trained to think only in terms of a static two-dimensional window, thus for those skilled in stained glass art a dynamic three-dimensional stained glass window is not an obvious option.

Additionally, the only external force being exerted on a traditional lead came stained glass window is gravity, so the primary limitation on the construction of a stained glass window is the highly malleable nature of the lead used to build these windows. Since lead will bend, stretch and ultimately slump while supporting the weight of a stained glass window (larger than a couple square feet in size), it must be reinforced with a stronger material. This is traditionally done using iron or steel bars soldered to the backside of the window for structural support. The support of a window frame is also required to keep a stained glass window from collapsing under its own weight. For the first time in history, my radical new design required dealing with the effects of centrifugal force on a stained glass window. There are a number of significant design issues that had to be addressed to create a stained glass window that would be able to survive the stress of being spun.

1. There is no window frame to support the outer edge of the window.

2. The lead used to construct the outer edge of the window is not strong enough to hold up to the pressures being applied by the drive wheels in contact with the outer edge of the window. Zinc can be used on the outer edge of a stained glass window, but it is not strong enough to survive being crushed by the pressure of the window against the drive wheels.

3. Gravity only puts stress on a stained glass window in a downward direction, but in my window centrifugal force puts stress on the window in all directions. The stress causes the lead, holding the window together; to stretch in all directions at the same time, so the natural tendency is for the window to fly apart.

While these issues may seem trivial at face value, the truth is that they are a major consideration in making the leap from traditional lead came stained glass windows to my new dynamic stained glass windows. To overcome these limitations, I had to develop the idea of using a steel bar bent into a circular shape that could be form fitted and soldered to the outer edge of my windows to provide:

1. The structural support necessary to replace the traditional support of a window frame.

2. An outer edge on the window that is strong enough to handle the pressure of the window against the drive wheels.

3. The ridged steel ring keeps the lead in the window from stretching and allows the window to withstand the stress of centrifugal force.

While steel bars are used to support a traditional lead came stained glass window from the back, nobody has ever used steel, shaped into a ring, to support the outer edge of a window. There has never been any reason to use steel in this manner as window frames normally support a traditional lead came stained glass window. When steel bars are soldered to the back of my windows and connected to the steel ring around the outer edge of the window, this forms a very stiff window that can withstand the centrifugal force of being spun.

Furthermore, the most radical leap in the conception of my dynamic stained glass window is the idea of motion in a stained glass window. For the last 15 centuries, nobody had conceived the idea of applying motion to a stained glass window to create a kaleidoscopic effect. Stained glass artists have never thought in terms of motion because the idea is so counter-intuitive to the function of a static stained glass window. The structural design considerations to support a dynamic stained glass window are counter-intuitive to the age-old concepts used to design a traditional lead came static stained glass window.

However, there remains the static nature of traditional lead came stain glass windows as well as modem simulations of stain glass. Furthermore, none of the simulations can provide the glowing beauty of real stain glass.

### DISCLOSURE OF THE INVENTION

The present invention provides advantages and alternatives over the prior art by providing a dynamic stain glass window assembly utilizing traditional stain glass pieces in a manner that provides for a moving light pattern, i.e., kaleidoscopic effect, to be displayed instead of a single image using natural daylight, artificial light, or both.

According to a further aspect of the present invention, there is provided a dynamic stain glass window assembly that may be mounted either vertically as is historically the manner static stain glass windows are mounted or horizontally for use as, for example, a sky light or tabletop surface.

According to yet another aspect of the present invention there is provided a dynamic stain glass window assembly having one fixed stain glass window and one moveably mounted stain glass window providing a moving light pattern to be displayed beyond the surface of the window in a predetermined pattern. The predetermined patterns can also be used as visual alert or alarm function similar to the audible signals on a traditional clock for example.

According to a yet further aspect of the present invention there is provided a dynamic stain glass window assembly having one fixed stain glass window and at least two moveably mounted stain glass windows providing a moving light pattern display.

According to still another aspect of the present invention there is provided a dynamic stain glass window assembly utilizing a fixed traditional lead came stain glass window and a moveable traditional lead came stain glass window creating a moving light pattern to be displayed comprising in cooperative combination; a display unit having a front, a back, a top, and bottom and a pair of sides for mounting and containing; a first lead came clear beveled glass window comprising a clear beveled glass patterned lead came stain glass window having a diameter of at least about three feet fixedly attached in said front of said display unit; a second lead came stain glass window comprising a desired pattern of colored stain glass mounted in lead came having a diameter of at least about three feet, moveably mounted within said display unit and positioned on the same horizontal axis as said first lead came stain glass window; a plurality of idler pulleys for said moveably mounted second lead came-stain glass window; a bogie wheel for said moveably mounted second lead came stain glass window; and a drive motor cooperatively connected to said bogie wheel for driving said bogie wheel and rotating said moveably mounted second lead came stain glass window; thereby creating a desired dynamically changing stain glass window image light pattern display.

According to still yet another aspect of the present invention there is provided a dynamic stain glass window assembly utilizing a fixed traditional lead came stain glass window and a plurality of moveable traditional lead came stain glass windows creating a moving light pattern to be displayed comprising in cooperative combination: a display unit having a front, a back, a top, and bottom and a pair of sides for mounting and containing; a first lead came stain glass window comprising a clear beveled glass patterned lead came stain glass window having a diameter of at least about three feet fixedly attached in said front of said display unit; a plurality of second lead came stain glass windows each comprising a desired pattern of colored stain glass mounted in lead came having a diameter of at least about three feet, moveably mounted within said display unit and positioned on the same horizontal axis as said first lead came stain glass window; a plurality of idler pulleys for each of said plurality of moveably mounted second lead came stain glass windows; a bogie wheel for each of said plurality of moveably mounted second lead came stain glass windows; and a drive motor cooperatively connected to each of said bogie wheels for driving said drive wheel and rotating said plurality of moveably mounted second lead came stain glass windows; thereby creating a desired dynamically changing lead came stain glass window image light pattern display.

As used herein the terms “stain glass” and “stain-glass” carries the usually understood meaning in the art, that is, hand poured glass that has a metallic oxide added to create a color change in the glass. However, it is to be understood that hand poured clear glass is also considered a “stain glass” or “stain-glass” even though no color is added. The distinction of being “stain glass” and “stain-glass” being hand pouring vs. glass created by machine. There are many different styles of clear stain glass including for example rippled, frosted, wavy, and beveled.

As used throughout the terms bogie wheel, drive wheel, and bogie/drive wheel are used interchangeably to identify the wheel that makes the stain glass windows rotate.

The present invention thus advantageously provides the beauty, artistry, and glowing image of a traditional lead came stain glass window using real stain glass pieces with the ability to provide a changing and moving light pattern.

### BRIEF DESCRIPTION OF THE DRAWINGS

FIG. 1 shows a perspective front view of one preferred embodiment of the present invention.

FIG. 2 show a perspective rear view of the rotating stain glass windows as mounted on the idler pulleys and driven by the bogie wheels as well as the drive assembly of one preferred embodiment of the present invention.

FIG. 3 shows a perspective view of a bogie/drive wheel suitable for use with a preferred embodiment of the present invention.

FIG. 4 shows a perspective view of an idler pulley suitable for use with a preferred embodiment of the present invention.

FIG. 5 shows a top plan view of a pair of idler pulleys mounted in an idler pulley mounting bracket of one preferred embodiment of the present invention.

FIG. 6 shows a top plan view of motor 12, reduction unit 12a of a drive motor, and motor drive shaft 12b suitable for use with the present invention.

FIG. 7 shows an end plan view of reduction unit 12a and motor drive shaft 12b of a drive motor suitable for use with the present invention.

FIG. 8 shows a plan view of the beveled gear orientation and location for use with the present invention.

FIG. 9 shows a plan rear view of the currently most preferred embodiment of the present invention.

FIG. 10 shows a plan side view of the currently most preferred embodiment of the present invention.

FIG. 11 shows a partial image of a dynamic stain glass window having a minor portion of beveled glass in each of the patterned stain glass windows.

FIG. 12 shows a partial image of a dynamic stain glass window the present invention where a pair of second windows is made of flat stain glass and the front window is made using beveled glass.

FIG. 13 shows a partial image of a currently preferred embodiment of the dynamic stain glass window of the present invention.

### DESCRIPTION OF THE PREFERRED EMBODIMENTS OF THE INVENTION

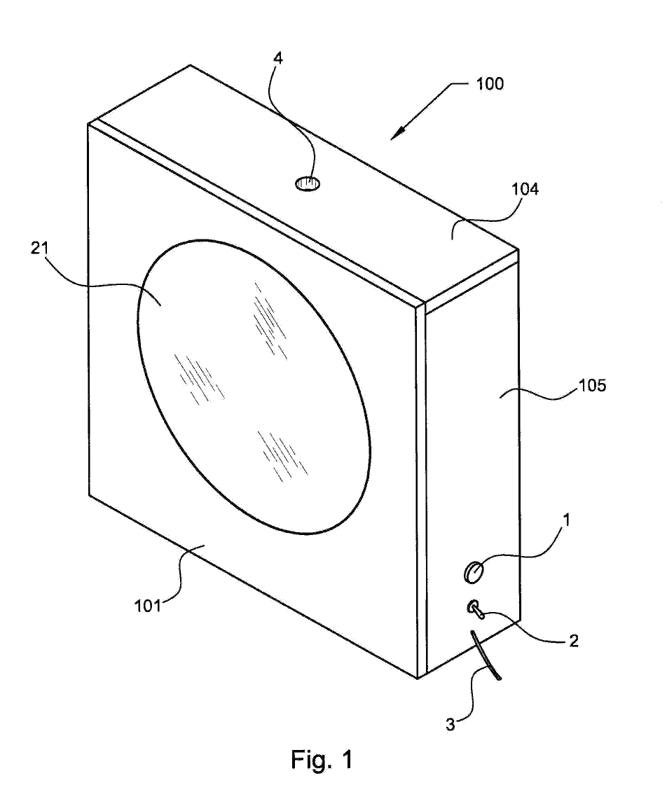

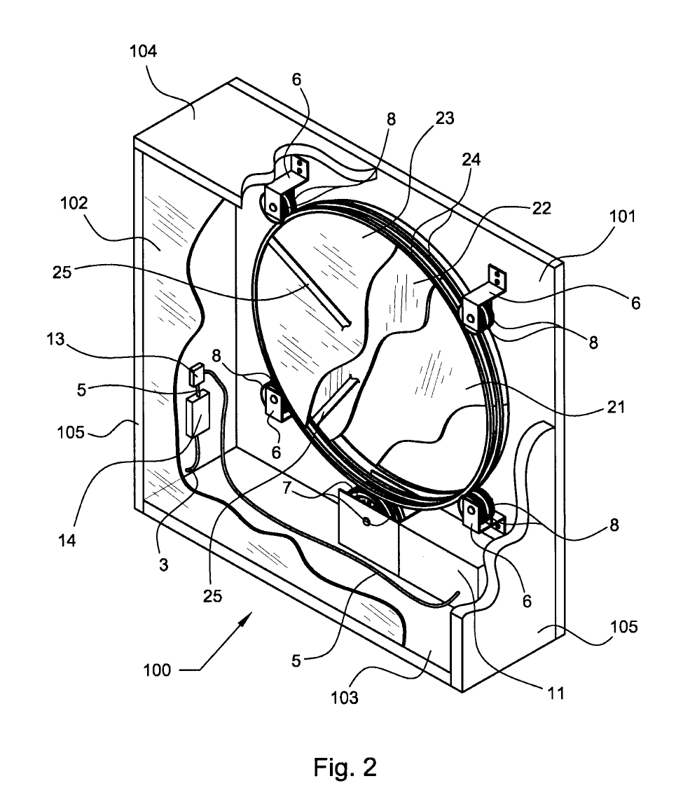

Reference will now be made to the drawings, wherein to the extent possible like reference numerals are utilized to designate like components throughout the various views. Referring to FIG. 1, which presents a perspective front view of one preferred embodiment of the present invention showing the front of a display container (100) having a front face 101, a rear face 102 (FIG. 2), a bottom 103 (FIG. 2), a top 104 (FIG. 2), and two side walls 105 (FIG. 2), said front face having fixedly mounted therein a first stain glass window 21, and one sidewall 105 having mounted thereon an ON/OFF power switch with rheostat 1, a polarity switch 2, a power cord 3, and a mounting bracket 4. The first stain glass window comprises clear beveled glass or a combination of clear beveled glass and plain stain glass, preferably clear beveled glass. The first stain glass having a desired design created by the shapes, sizes, and number of glass pieces used to complete the desired window design.

Referring now to FIG. 2 there is shown a perspective rear view of one preferred embodiment of the present invention showing the first stain glass window 21 fixedly mounted in the front face 101 of display unit 100, also shown are the rear face 102 which is light transparent, sidewalls 105, top 104 having a mounting bracket 4 (FIG. 1) located therein, and bottom 103.

As further shown in FIG. 2, there are a second stain glass window 22 and a third stain glass window 23 both moveably mounted parallel to one another and to said first stain glass window 21, and further all said stain glass windows being on the same horizontal axis. Said second and third stain glass windows 22 and 23 having the same circular geometry and size as said first stain glass window 21. The second and third stain glass windows 22 and 23 are preferably constructed of stain glass sections having the same or different desired patterns. Said second stain glass window 22 and said third stain glass window 23 being moveably mounted on four sets of idler pulleys 8. Said four sets of idler pulleys 8 comprising four pair of idler pulleys 8 each said pair mounted in an idler pulley mounting bracket 6 and the four mounting brackets 6 being fixedly attached to the back side of front face 101 of display unit 100. It is to be understood that said idler pulley mounting brackets 6 may alternatively be mounted to the sidewalls 105, the top 104, the bottom 103 or any combination thereof.

As also shown in FIG. 2, is the motor mounting unit 11 having beveled drive gear 9 (FIG. 8) engaging complementary beveled drive wheel gears 10 (FIG. 8), said beveled drive wheel gears each being fixedly mounted to a bogie/drive wheel 7. The outer surface of each of bogie/drive wheels 7 frictionally engaging the outer rim of one of moveably mounted stain glass windows 22 and 23.

Finally, also shown in cooperative combination are associated connecting wiring 5, motor 12 (FIGS. 6 and 8) within motor mounting unit 11, a Power Control Unit 13 to which the ON/OFF power switch with rheostat 1 and polarity switch 2 are connected, an AC/DC converter 14, and power cord 3.

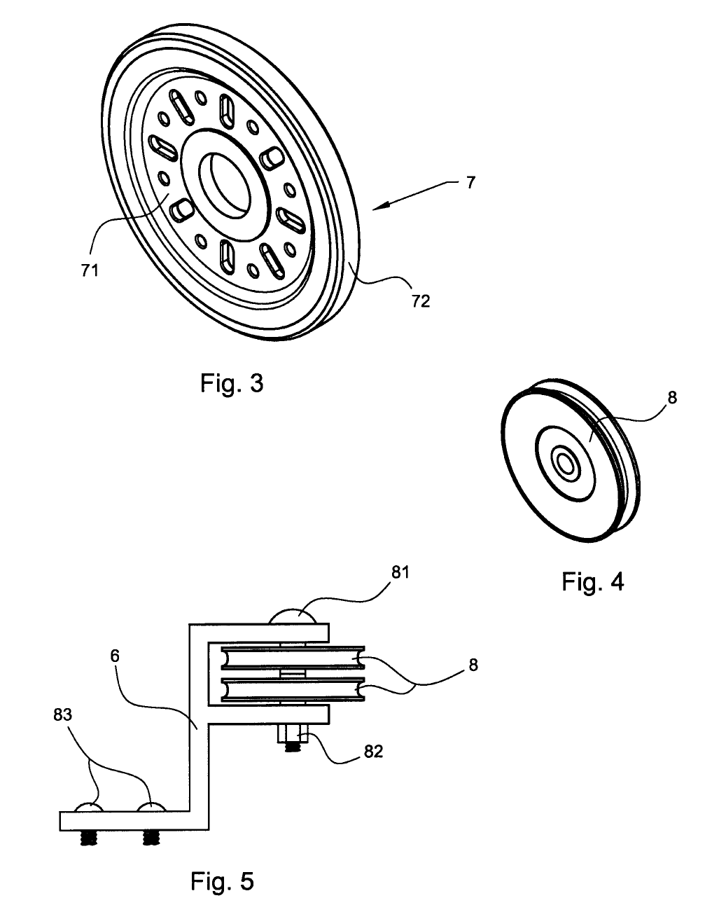

FIG. 3 shows perspective view of a presently preferred bogie wheel or drive wheel 7 and FIG. 4 shows a perspective view of a presently preferred idler pulley 8.

Turning to FIG. 5, there is shown a plan view of a pair of idler pulleys 8 moveably mounted by way of mounting bolt 81 and mounting nut 82 within idler pulley mounting bracket 6. Also shown are mounting fasteners 83 for fixedly mounting said idler pulley mounting bracket 6 within said display unit 100.

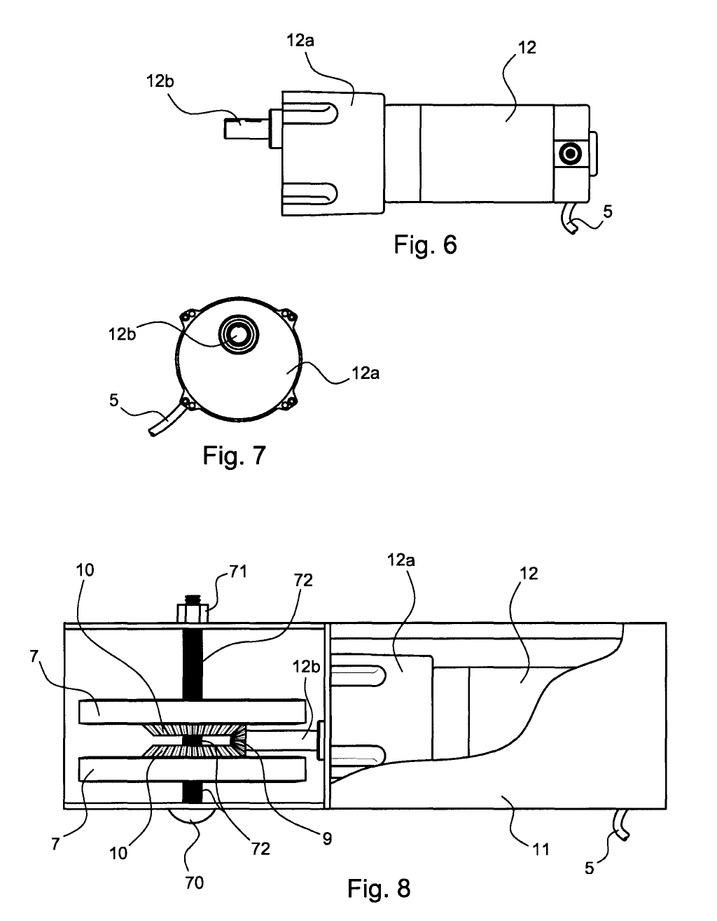

FIG. 6 shows a top plan view of the drive motor 12 with gear reduction unit 12a and drive shaft 12b. FIG. 7 shows an end plan view of the gear reduction unit 12a and drive shaft 12b.

Turning to FIG. 8 there is shown a schematic top view of the drive motor 12 with gear reduction unit 12a and drive shaft 12b with beveled drive gear 9 cooperatively combined with a pair of beveled drive wheel gears 10 each said beveled drive wheel 10 mounted on the face of a drive wheel 7. The bogie/drive wheels 7 and the beveled bogie/drive wheel gears are mounted through their center axes by a mounting fastener 70, spacers 72, and fastener nut 71 onto motor mounting unit 11.

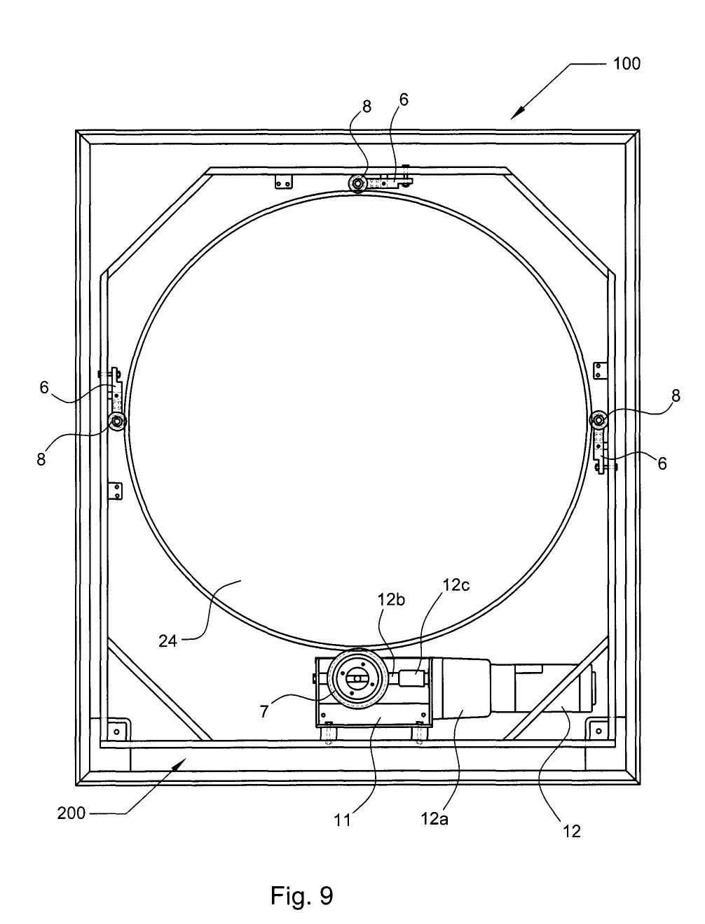

FIG. 9 shows a rear plane view of the currently preferred embodiment of the claimed invention wherein the window components, including three idler pulley mounting brackets 6, three sets of idler pulleys 8, motor mounting unit 11 having beveled drive gear 9 (FIG. 8) engaging complementary beveled drive wheel gears 10 (FIG. 8), said beveled drive wheel gears each being fixedly mounted to a bogie/drive wheel 7. The outer surface of each of bogie/drive wheels 7 frictionally engaging the outer rim of one of moveably mounted stain glass windows 22 and 23, drive motor 12 with gear reduction unit 12a, drive shaft 12b and coupling 12c, as well as rotationally moveable mounted stain glass windows 22 and 23 are first fixedly mounted within and to a metal cage 200 and then said metal cage 200 is fixedly mounted within display unit 100.

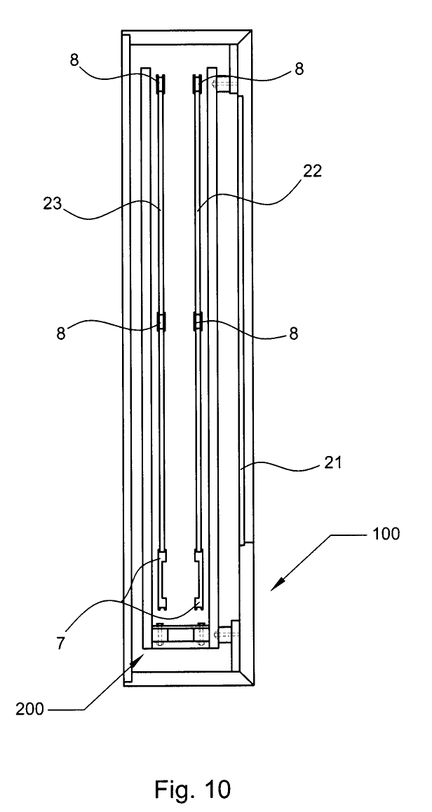

FIG. 10 shows an end plan view of the currently preferred embodiment of the claimed invention wherein the fixedly mounted first stain glass window 21 is mounted to display unit 100; idler pulleys 8, bogie/drive wheels 7, metal cage 200, and moveably mounted stain glass windows 22 and 23 are also shown.

FIG. 11 shows a portion of a dynamic stain glass window comprising a first window made of clear glass wherein the clear beveled stain glass pieces each have more surface area comprising surface in line with the plane of the window than beveled surface area. And a pair of second windows made of flat colored stain glass in a desired pattern. Here the color patterns change producing a dynamic effect but there is very little kaleidoscopic effect produced. In fact only the center area of this window produces kaleidoscopic effect. Thus the colored patterns of each of the pair of second windows remain very much clear and sharp. These effects are visible from in front of the stained glass windows because the light source is located behind the stain glass windows.

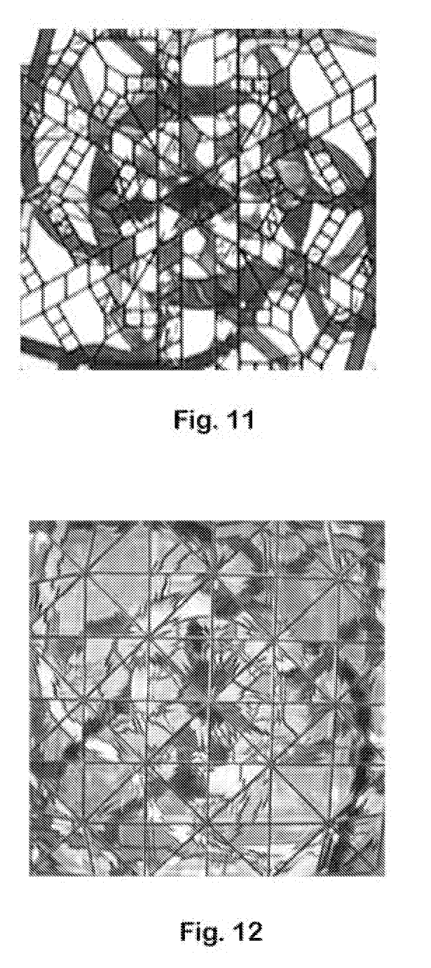

FIG. 12 shows a portion of a dynamic stain glass window comprising the same pair of second colored stain glass windows but with a first stain glass window made of clear beveled stain glass in a desired pattern and having the beveled surface areas equal to or greater than the flat inline surface areas of each individual piece of clear beveled stain glass. The beveled glass pieces may also be described as having total outer circumference of from about twelve inches to about fourteen inches. It has been found that such clear beveled glass pieces with said outer circumference and flat to beveled glass surface area ratio produce the most desirable kaleidoscopic effect. Now the pattern of each of the second pair of windows as well as the patterns created by these two windows rotating in relation to one another are not always clear and sharp but are bent, made out of focus, i.e., fuzzy and blurred, and even made to disappear due to the effects of refraction caused by the high amount of beveled surface area. This is the kaleidoscopic effect desired. Here again the light source is behind all of the windows.

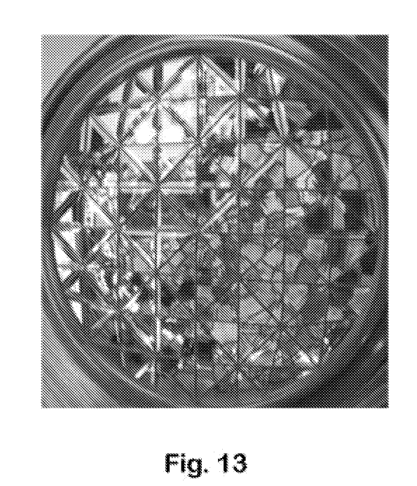

Finally, FIG. 13 shows a portion of a dynamic stain glass window comprising the same first stain glass window made of clear beveled stain glass of FIG. 12 with a pair of second colored stain glass windows. Each of these second stain glass windows has a desired pattern intermixing clear colorless stain glass pieces and colored stain glass pieces in an approximately 50:50 ratio. Suitable ratios of clear stain glass pieces to colored stain glass pieces are from about 75:25 to about 25:75, preferably from about 60:40 to about 40:60, and most preferably from about 45:55 to about 55:45. This combination of a first stain glass window having clear beveled stain glass comprising pieces having a total outer circumference of from about twelve inches to about fourteen inches and second stain glass windows having the above mentioned ratio of clear stain glass to colored stain glass, produces more desirable kaleidoscopic effects. The dynamic stain glass window of this figure is the presently preferred window construction of the claimed invention. The white light in the upper left of the dynamic stain glass window is the reflection of a flood lamp used to illuminate the dynamic stain glass window during filming of the dynamic stain glass window in operation and is not an effect of the invention itself.

In practice the mounting of the beveled drive gear 9 between the pair of parallel mounted beveled drive wheel gears 10 results in stain glass windows 22 and 23 rotating in opposite directions to one another. However, it is to be understood that the gears may be configured to make both stain glass windows 22 and 23 rotate in the same direction. The movement of the stain glass windows 22 and 23 and the preferred beveled stain glass composition of the first stain glass window 21 provided for a dynamic and changing light pattern, kaleidoscopic effect, to the viewer of the window.

The presently preferred stain glass windows are designed and constructed using common well known materials and techniques. Further, the presently preferred windows all have a diameter of at least about 3 feet. The windows do require a support outer metal frame 24 and structural frame support members 25 mounted across the diameter of the windows to provide the necessary window stability such that the stain glass section and the lead came are not damaged or loosened. The presently preferred window outer frame 24 and structural frame support members 25 comprise steel flat bar stock.

It is to be appreciated that the present invention may be lighted from the back through the light transparent back 102 by natural sunlight it may also or alternatively be lighted by artificial light form any of many known artificial light sources. The transparent back 102 may be composed of any suitable and well known material such as, for example, glass, acrylic, and the like. The presently preferred material is clear acrylic sheet. It is also to be appreciated that the use of artificial light sources to light the window of the present invention is contemplated either in the alternative, or in addition to, natural light.

Suitable motors to drive the claimed invention are well known in the art as are the bogie wheels and idler pulleys, as well as beveled drive gears and beveled drive wheel gears. A presently preferred drive motor with an integral gear reduction unit is model GPP7458 supplied by Baldor Electric Company. Presently preferred bogie wheels are available as model 480-0019 and the presently preferred Idler Pulleys are available as model 416-0017 both being supplied by Capital Stamping Company. Presently preferred bevel gears are model L149Y-G for mounting on the bogie wheels and model L149Y-P for the bevel gear attached to the motor drive shaft both supplied by the Boston Gear Company. These devices are also well known in the art and suitable alternatives will be easily obtainable by those skilled in the art. It is to be understood that a similar AC motor would also be suitable, but a DC motor is preferred. The advantage of a DC motor is that coupled with a rheostat it allows for easy and efficient changing of the motor speed and therefore the speed of rotation of the stain glass windows. This in turn allows for the light patterns to change in effect from a gentle rhythmic low speed oscillation to a higher speed pulsating type oscillation of the light patterns. Another advantage of the DC motor is that the direction of rotation of the windows can be reversed by simply using a polarity switch in the electrical circuit as is illustrated in the preferred embodiment. The use of a polarity switch to change the direction of rotation and of a rheostat to change the speed of rotation provides for a plurality of lighting effects.

One particularly preferred embodiment of the present invention provides for a dynamic stain glass window assembly utilizing a fixed traditional lead came clear beveled glass pattern window, having a diameter of at least about three feet, and a moveable traditional lead came stain glass window, having a diameter of at least about three feet, creating a moving light pattern to be displayed comprising in cooperative combination: a display unit having a front, a back, a top, and bottom and a pair of sides for mounting and containing: a first stain glass window fixedly attached in said front of said display unit; a second stain glass window moveably mounted within said display unit and positioned on the same horizontal axis as said first stain glass window; a plurality of idler pulleys for said moveably mounted second stain glass window; a drive wheel for said moveably mounted second stain glass window; and a drive motor cooperatively connected to said drive wheel for driving said drive wheel and thereby rotating said moveably mounted second stain glass window; thereby creating a dynamically changing stain glass window image.

Another particularly preferred embodiment of the present invention provides for a dynamic stain glass window assembly utilizing a fixed traditional lead came clear beveled glass pattern window, having a diameter of at least about three feet, and a plurality of moveable traditional lead came stain glass windows, each having a diameter of at least about three feet, creating a moving light pattern to be displayed comprising in cooperative combination: a display unit having a front, a back, a top, and bottom and a pair of sides for mounting and containing: a first stain glass window fixedly attached in said front of said display unit; a plurality of second stain glass windows moveably mounted within said display unit and positioned on the same horizontal axis as said first stain glass window; a plurality of idler pulleys for each of said plurality of moveably mounted second stain glass windows; a drive wheel for each of said plurality of moveably mounted second stain glass windows; and a drive motor cooperatively connected to each of said drive wheels for driving said drive wheel and thereby rotating said plurality of moveably mounted second stain glass windows; thereby creating a dynamically changing stain glass window image.

Yet another particularly preferred embodiment of the present invention provides for a dynamic stain glass window assembly wherein the first clear beveled stain glass window is composed of individual pieces of clear beveled stain glass where the surface area of the beveled portion is almost equal to or equal to or greater than the surface area of the flat portion and all are mounted in lead came. Additionally, it is particularly preferred to design the color stain glass windows to have ratios of clear stain glass pieces to colored stain glass pieces are from about 75:25 to about 25:75, preferably from about 60:40 to about 40:60, and most preferably from about 45:55 to about 55:45.

Although the preferred embodiments of the present invention has been disclosed, various changes and modifications may be made without departing from the scope of the invention as set forth in the appended claims.

What is claimed is:

1. A dynamic stain glass window assembly utilizing a fixed traditional lead came stain glass window and a moveable traditional lead came stain glass window creating a moving light pattern to be displayed comprising in cooperative combination:
a) a display unit having a front, a back, a top, and bottom and a pair of sides for mounting and containing;
b) a first lead came clear beveled glass window comprising a clear beveled glass patterned lead came stain glass window wherein each piece of clear beveled glass has a circumference of from about twelve to about fourteen inches, and further having a diameter of at least about three feet fixedly attached in said front of said display unit;
c) a second lead came stain glass window comprising, a desired pattern of interspersed clear stain glass pieces and colored stain glass pieces mounted in lead came having a ratio of clear stain glass to colored stain glass of about 75:25, and having a diameter of at least about three feet, moveably mounted within said display unit and positioned on the same horizontal axis as said first lead came stain glass window;
d) a plurality of idler pulleys for said moveably mounted second lead came stain glass window;
e) a bogie wheel for said moveably mounted second lead came stain glass window; and
f) a drive motor cooperatively connected to said bogie wheel for driving said bogie wheel and rotating said moveably mounted second lead came stain glass window; thereby creating a desired dynamically changing stain glass window image light pattern display.

2. A dynamic stain glass window assembly utilizing a fixed traditional lead came stain glass window and a plurality of moveable traditional lead came stain glass windows creating a moving light pattern to be displayed comprising in cooperative combination:
a) a display unit having a front, a back, a top, and bottom and a pair of sides for mounting and containing;
b) a first lead came clear beveled glass window comprising a clear beveled glass patterned lead came stain glass window wherein each piece of clear beveled glass has a circumference of from about twelve to about fourteen inches, and further having a diameter of at least about three feet fixedly attached in said front of said display unit;
c) a plurality of second lead came stain glass windows each comprising, a desired pattern of interspersed clear stain glass pieces and colored stain glass pieces mounted in lead came having a ratio of clear stain glass to colored stain glass of about 75:25, and having a diameter of at least about three feet, moveably mounted within said display unit and positioned on the same horizontal axis as said first lead came stain glass window;
d) a plurality of idler pulleys for each of said plurality of moveably mounted second lead came stain glass windows;
e) a bogie wheel for each of said plurality of moveably mounted second lead came stain glass windows; and
f) a drive motor cooperatively connected to each of said bogie wheels for driving said drive wheel and rotating said plurality of moveably mounted second lead came stain glass windows;
thereby creating a desired dynamically changing lead came stain glass window image light pattern display.

3. The dynamic lead came stain glass window assembly as claimed in claim 2 wherein, said plurality of moveably mounted second lead came stain glass windows comprise two stain glass windows having a desired pattern of colored flat stain glass mounted in lead came.

4. The dynamic lead came stain glass window assembly as claimed in claim 1 wherein, said second lead came stain glass window comprises a desired pattern of colored flat stain glass mounted in lead came.

5. The dynamic lead came stain glass window assembly as claimed in claim 2 wherein, said plurality of second lead-came stain glass windows each comprise a desired pattern of colored flat and beveled stain glass mounted in lead came.

6. The dynamic lead came stain glass window assembly as claimed in claim 2 wherein, at least one of said plurality of second lead came stain glass patterned windows comprise a desired pattern of colored flat stain glass mounted in lead came, and at least one other of said plurality of second lead came stain glass patterned windows comprise a desired pattern of beveled stain glass mounted in lead came.

7. The dynamic lead came stain glass window assembly as claimed in claim 5 wherein, said plurality of second lead-came stain glass patterned windows all have different patterns.

8. The dynamic lead came stain glass window assembly as claimed in claim 4 wherein, said second lead came stain glass window comprises a desired pattern of colored flat stain glass mounted in lead came having a ratio of clear stain glass pieces to colored stain glass pieces are from about 75:25 to about 25:75, preferably from about 60:40 to about 40:60, and most preferably from about 45:55 to about 55:45.

9. The dynamic lead came stain glass window assembly as claimed in claim 3 wherein, said second lead came stain glass windows each comprise a desired pattern of colored flat stain glass mounted in lead came having ratios of clear stain glass pieces to colored stain glass pieces are from about 75:25 to about 25:75, preferably from about 60:40 to about 40:60, and most preferably from about 45:55 to about 55:45.

10. The dynamic lead came stain glass window assembly as claimed in claim 1 wherein, said first lead came stain glass windows each comprises a desired pattern of clear beveled stain glass mounted in lead came having more beveled surface area than flat surface area.

11. The dynamic lead came stain glass window assembly as claimed in claim 2 wherein, said first lead came stain glass windows each comprises a desired pattern of clear beveled stain glass mounted in lead came having more beveled surface area than flat surface area.

12. The dynamic lead came stain glass window assembly as claimed in claim 2 wherein, said plurality of second came stain glass windows rotate in opposing directions to each other.

13. The dynamic lead came stain glass window assembly as claimed in claim 1 wherein, said second lead came stain glass window has a variable speed of rotation.

14. The dynamic lead came stain glass window assembly as claimed in claim 13 wherein, said variable speed of rotation is controlled by a rheostat.

15. The dynamic lead came stain glass window assembly as claimed in claim 2 wherein, said plurality of second lead came stain glass windows has a variable speed of rotation.

16. The dynamic lead came stain glass window assembly as claimed in claim 15 wherein, said variable speed of rotation is controlled by a rheostat.

17. The dynamic lead came stain glass window assembly as claimed in claim 1 wherein, all of said lead came stain glass windows are mounted vertically.

18. The dynamic lead came stain glass window assembly as claimed in claim 1 wherein, all of said lead came stain glass windows are mounted horizontally.

19. The dynamic lead came stain glass window assembly as claimed in claim 2 wherein, all of said lead came stain glass windows are mounted vertically.

20. The dynamic lead came stain glass window assembly as claimed in claim 2 wherein, all of said lead came stain glass windows are mounted horizontally.
